(19) United States
(12) Patent Application Publication
(10) Pub. No.: US 2024/0037620 A1
(43) Pub. Date: Feb. 1, 2024

(54) Systems and Methods for Verifying Transaction Authenticity Using Securitized Token-Based System

(71) Applicant: Yoorang LLC, New York, NY (US)

(72) Inventors: Doron J. Fetman, New York, NY (US); Toby Hassan Fishman, New York, NY (US); Jonathan Kopnick, Long Island City, NY (US)

(21) Appl. No.: 18/226,611

(22) Filed: Jul. 26, 2023

Related U.S. Application Data
(60) Provisional application No. 63/369,527, filed on Jul. 27, 2022.

(51) Int. Cl. G06Q 30/0601

(52) U.S. Cl. CPC G06Q 30/0609

(57) ABSTRACT

Systems and methods for providing an online exchange system. The methods comprise: performing, by a computing device of the online exchange system, a first transaction in which an ownership of a collectible is exchanged for an electronic financial instrument backed by at least one asset having a tangible value; generating, by the computing device, a non-fungible token on a first digital ledger for verifying ownership of the collectible; and communicating information from the computing device to a system which generated the electronic financial instrument such that a block is added to a second digital ledger that indicates a change of ownership of the electronic financial instrument occurred during the first transaction.

### CROSS-REFERENCE TO RELATED APPLICATIONS

The present application claims priority to and the benefit of U.S. Provisional Patent Application No. 63/369,527 which was filed on Jul. 27, 2022. The content of this Provisional patent application is incorporated herein in its entirety.

### BACKGROUND

Many e-commerce websites and app-based online platforms allow individual users to buy and sell physical items. On some such sites, the items may be unique items such as original artwork, sports memorabilia, limited edition shows or other wearable items, autographed items, or other collectibles. Proving authenticity of the collectibles and eliminating fraud is a serious concern in such marketplaces. Users must rely on printed certificates of authenticity, which themselves may be fraudulently created. Technical solutions for proving authenticity of physical collectibles are lacking.

In addition, on online auction marketplaces, sellers can sometimes use so-called “straw men” or bots to submit fake bids in an attempt to prompt higher bids from real customers. Technical solutions for determining whether a bidder in an online auction is a legitimate bidder or a fake one also are lacking. This further erodes trust in online collectible marketplaces.

A blockchain is a digital ledger for recording transaction information in a way that is difficult to change. Blockchains are often used to record and track transactions relating to assets in a business network. The digital ledger comprises a plurality of blocks that are linked together using cryptography. Each block contains a cryptographic hash of the previous block, a timestamp and transaction data.

A non-fungible token, commonly known as an NFT, is a unique, non-interchangeable, digital object that is stored on a blockchain. NFTs can be sold or otherwise traded, and they include digital terms (known as a smart contract) governing their transfer. NFTs are often associated with (and sometimes include) digital objects such as photos, digital artwork, or video or music files. More recently, NFTs have also been linked to physical assets, such as real estate or luxury products, to maintain a record of a chain of title record for the assets. However, current systems that use NFTs to verify ownership of a physical item are very difficult to use, as they typically require users to convert between multiple token types across multiple platforms to acquire an asset. They also lack any means to verify delivery of a physical asset to the buyer.

This document describes methods and systems that are directed to addressing at least some of the issues described above, and/or other issues.

### SUMMARY

The present disclosure concerns methods for providing an online exchange system. The methods comprise: performing, by a computing device of the online exchange system, a first transaction in which an ownership of a collectible is exchanged for an electronic financial instrument (e.g., a securitized token) backed by at least one asset having a tangible value (e.g., at least one unit of equity ownership in a corporation); generating, by the computing device, a non-fungible token on a first digital ledger for verifying ownership of the collectible; and communicating information from the computing device to a system (e.g., a security token offering system) which generated the electronic financial instrument such that a block is added to a second digital ledger that indicates a change of ownership of the electronic financial instrument occurred during the first transaction. The first and second digital ledgers may be the same digital ledger or different digital ledgers. A fractional share of ownership in the collectible may optionally have been exchanged for the electronic financial instrument during the first transaction.

The methods may also comprise: offering, by the online exchange system, an ability to exchange currency for an option contract granting a right to buy the collectible at a set price on or before a certain date; completing, by the computing device, a second transaction in which the currency is exchanged for the option contract; and/or performing operations by the computing device to modify the first digital ledger to include information specifying details of the second transaction. Terms of the option contract may be set in accordance with a policy defined in the non-fungible token.

Additionally or alternatively, the methods further comprise: offering, by the online exchange system, an ability to borrow or loan the collectible in exchange for currency in accordance with a policy defined in the non-fungible token; performing operations by the computing device to complete a third transaction for borrowing or loaning the collectible and modifying the first digital ledger to include information specifying details of the third transaction; continuously varying a price of the collectible based on an index, historical transaction data, and purchase transaction data received from other online exchange systems; tracking changes in physical custody of the collectible and encoding tracking updates into the first digital ledger so as to be tied to transaction history of the non-fungible token; and/or authenticating an identity of an individual prior to allowing the individual access to the online exchange system. The non-fungible token may be configured to verify ownership of one or more securitized tokens in addition to the ownership of the collectible.

The methods may additionally or alternatively comprise: generating and presenting a single graphical user interface simultaneously displaying streaming quotes for auctioned collectibles, non-functional tokens and derivatives; organizing assets of a plurality of different platforms in accordance with a data taxonomy that is defined by at least one of an asset class, a year of creation of a collectible, a company that made the collectible, a unique identifier for the collectible, a collectible type, a rating or verification agency classification, a fractionalization exchange offering indicator, an origin auction house identifier, and a listing expiration date; and/or using artificial intelligence or machine learning algorithm(s) to: (i) automatedly identify patterns or trends relating to collectibles amongst individuals based on electronic content accessible on a network; (ii) discover insights, predict trends and/or make forecasts in the collectible industry based on unstructured data flowing through the online exchange system; (iii) make recommendations for the exchange of collectibles based on the patterns or trends relating to collectibles and/or historical transaction data; or (iv) provide a chatbot configured to simulate conversation with individuals for facilitating trading.

The present disclosure also concerns a system comprising a processor; and a non-transitory computer-readable storage medium comprising programming instructions that are configured to cause the processor to implement a method for providing an online exchange system. The programming instructions comprise instructions to: perform a first transaction in which an ownership of a collectible is exchanged for an electronic financial instrument backed by at least one asset having a tangible value; generate a non-fungible token on a first digital ledger for verifying ownership of the collectible; and communicate information from the computing device to a system which generated the electronic financial instrument such that a block is added to a second digital ledger that indicates a change of ownership of the electronic financial instrument occurred during the first transaction.

The first and second digital ledgers may be the same digital ledger or different digital ledgers. The electronic financial instrument may comprise a securitized token. The system may comprise a security token offering system. The asset may comprise at least one unit of equity ownership in a corporation A fractional share of ownership in the collectible may have been exchanged for the electronic financial instrument during the first transaction.

The programming instructions may also comprise instructions to: offer an ability to exchange currency for an option contract granting a right to buy the collectible at a set price on or before a certain date; complete a second transaction in which the currency is exchanged for the option contract; and/or modify the first digital ledger to include information specifying details of the second transaction. The terms of the option contract may be set in accordance with a policy defined in the non-fungible token.

Additionally or alternatively, the programming instructions further comprise instructions to: offer an ability to borrow or loan the collectible in exchange for currency in accordance with a policy defined in the non-fungible token; complete a third transaction for borrowing or loaning the collectible and modifying the first digital ledger to include information specifying details of the third transaction; and/or continuously vary a price of the collectible based on an index, historical transaction data, and purchase transaction data received from other online exchange systems.

Additionally or alternatively, the programming instructions further comprise instructions to: track changes in physical custody of the collectible and encode tracking updates into the first digital ledger so as to be tied to transaction history of the non-fungible token; and/or authenticate an identity of an individual prior to allowing the individual access to the online exchange system. The non-fungible token may be configured to verify ownership of one or more securitized tokens in addition to the ownership of the collectible.

### BRIEF DESCRIPTION OF THE DRAWINGS

The present solution will be described with reference to the following drawing figures, in which like numerals represent like items throughout the figures.

FIG. 1 provides an illustration of an illustrative system implementing the present solution.

FIG. 2 shows a screen shot of an e-commerce webpage auctioning a collectible.

FIG. 3 provides an illustration of another illustrative system implementing the present solution.

FIGS. 4A and 4B each provides an illustration of chain.

FIG. 5 provides an illustration of a computing device.

FIGS. 6A-6B (collectively referred to as “FIG. 6”) provides an illustration of another system implementing the present solution.

FIGS. 7A-7B (collectively referred to as “FIG. 7”) provides an illustration that is useful for understanding differences between the present solution and conventional Security Token Offering (STO) offering processes.

FIGS. 8A-8B (collectively referred to as “FIG. 8”) provides an illustration that is useful for understanding how a smart contract process of the present solution differs from conventional smart contract processes.

FIGS. 9A-9B (collectively referred to as “FIG. 9”) provides an illustration that is useful for understanding differences between an auction process of the present solution and conventional auction processes.

FIGS. 10A-10B (collectively referred to as “FIG. 10”) provides an illustration that is useful for understanding a data taxonomy.

FIG. 11 provides an illustration of a ticker Graphical User Interface (GUI).

FIG. 12 provides an illustration showing how a user can drill down on specific item listings and indexes using the ticker GUI of FIG. 11.

FIG. 13 provides an illustration showing a data taxonomy that allows for market data to be viewed at multiple levels simultaneously.

FIGS. 14-16 provide illustrations of displayed information.

FIGS. 17A-17B (collectively referred to as “FIG. 17”) provides an illustration that is useful for understanding differences between a collectible lending process of the present solution and conventional securities lending processes.

FIG. 18 provides a flow diagram of an illustrative method for providing an online exchange system.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment of the present solution. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Reference throughout this specification to “one embodiment”, “an embodiment”, or similar language means that a particular feature, structure, or characteristic described in connection with the indicated embodiment is included in at least one embodiment of the present solution. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

A futures market is an auction market where participants buy and sell commodities and/or securities for delivery on specified future date(s) in accordance with futures contract terms. The United States Securities and Exchange Commission (“SEC”) and the Commodity Futures Trading Commission (“CFTC”) jointly regulate the trading of futures on single securities and narrow-based security indexes (i.e., security futures products), that have features of both futures and securities. A futures contract is a derivative that is intended to lock in future delivery of a commodity or security at a price set as of the contract execution date. The futures contract is intended to protect the seller's profit regardless of price changes in the market since (s)he locked in the purchase price for the commodity at the time of contract execution. An option contract is a derivative where a fee is paid for the right, but not the obligation, to buy and sell the underlying asset(s) at its current price on or before an expiration date. Consequently, the option contract may expire without any securities and/or commodities being bought or sold. Some of these futures and/or derivatives markets may be traded over-the-counter (“OTC”) through an electronic communications network (“ECN”) or by way of an “open outcry” trading floor/pit model. Again, some derivatives are traded on exchanges that may be regulated by the SEC or CFTC.

The present disclosure concerns implementing systems and methods for providing an online exchange system for collectible(s), securitized token(s), NFT(s) and/or derivatives. The methods comprise: performing, by a computing device of the online exchange system, a first transaction in which an ownership of a collectible is exchanged for an electronic financial instrument backed by at least one asset having a tangible value; generating, by the computing device, an NFT on a first digital ledger for verifying ownership of the collectible; and communicating information from the computing device to a system which generated the electronic financial instrument such that a block is added to a second digital ledger that indicates a change of ownership of the electronic financial instrument occurred during the first transaction. The first and second digital ledgers can be the same digital ledger or different digital ledgers.

A price of the collectible may be variable based on an index, historical transaction data, and purchase transaction data received from other online exchange systems. Changes to the price can occur in real time or near real time as transactions are completed via the other online exchange systems. The electronic financial instrument can include, but is not limited to, a securitized token. In this case, the system that generated the securitized token comprises a security token offering system. The security token offering system may be part of the online exchange system or an external system to the online exchange system. The asset can include, but is not limited to, unit(s) of equity ownership in a corporation (for example, corporate share(s)) and/or collectible(s). All or a fractional share of ownership in the collectible may be exchanged for the electronic financial instrument during the first transaction.

In some scenarios, the online exchange system offers option derivatives providing an ability to exchange currency for an option contract granting a right to buy the collectible at a set price on or before a certain date. The terms of the option contract may be set in accordance with a policy defined in the NFT. A second transaction may be completed in which the currency is exchanged for the option contract. The first digital ledger may be modified to include information specifying details of the second transaction.

In those or other scenarios, the online exchange system offers an option which provides an ability to borrow or loan the collectible in exchange for currency. The terms of the option may be set in accordance with a policy defined in the NFT. A third transaction may be completed for borrowing or loaning the collectible. The first digital ledger may be modified to include information specifying details of the third transaction.

The online exchange system may track changes in physical custody of the collectible. For example, the collectible may be shipped by a third-party shipping company from a facility of the online exchange system to a facility of the owner. The third-party shipping company may communicate shipment tracking information to the online exchange system. Upon receipt of the shipment tracking information, the online exchange system performs operation to encode tracking updates into the first digital ledger so as to be tied to transaction history of the non-fungible token.

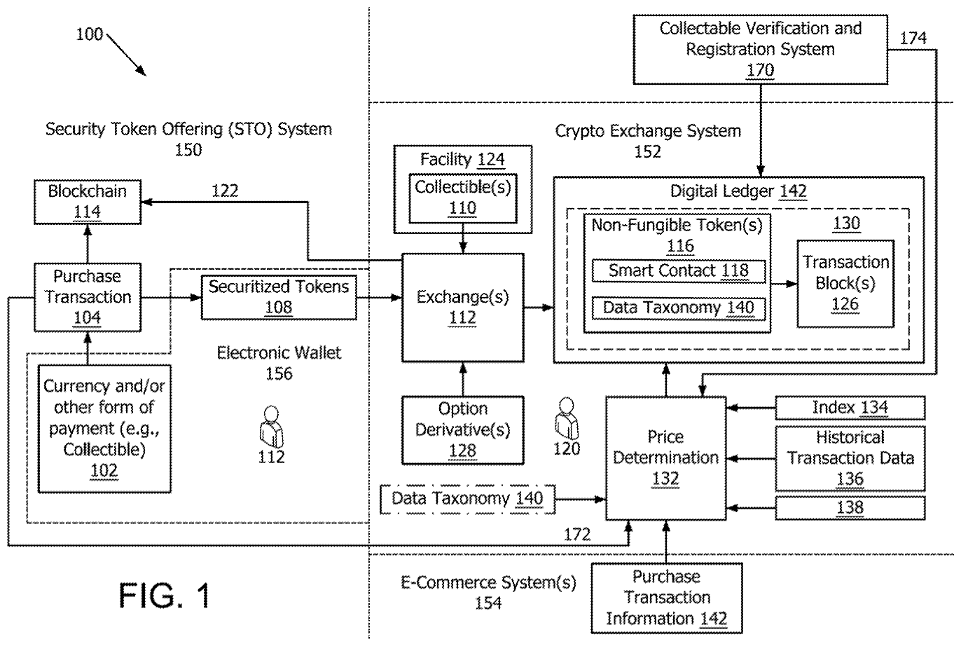

Referring now to FIG. 1, there is provided a block diagram 100 that is useful for understanding a novel process in which collectibles 110 are exchanged for securitized tokens 108 and/or other forms of currency. The novel process is implemented by an STO system 150, a crypto exchange system 152 and a Collectible Verification and Registration (CVR) system 170. These systems 150, 152, 170 can collectively comprise a single combined system operated by a given business entity or multiple systems respectively operated by different business entities.

A securitized token is a financial instrument that has a monetary value and is intended for trading on crypto exchange platforms. The securitized tokens are backed by one or more assets that have a tangible value. The asset(s) can include, but is(are) not limited to, collectible(s) and/or other units of equity ownership in a corporation (for example, corporate share(s), stock and bonds tied to a real company). The securitized tokens can be generated by an STO system 150 in a blockchain environment.

The securitized tokens 108 can be purchased by individual(s) 112 using currency 102 and/or other forms of payment. Details of the purchase transaction 104 are recorded in a blockchain 114. Blockchain 114 may comprise a publicly shared ledger. Currency 102 can include any known or to be known currency (for example, dollars, other fiat currency, or cryptocurrency such as Bitcoin or Ethereum, etc.). The other forms of payment can include, but are not limited to, physical goods (such as collectible(s)). Currency 102 can be stored in electronic wallet(s) 156 of the individual(s) 112. The securitized tokens 104 are then stored in the electronic wallet(s) 156 of the individual(s) 112.

The identities of the individuals 112 may be validated and/or authenticated prior to their access to the STO platform and/or the crypto exchange platform(s). The validation and/or authentication can be achieved using any known or to be known validation/authentication technique. For example, the individual's identity can be validated/authenticated in accordance with a Know Your Customer (KYC) authentication technique and/or an Anti-Money Laundering (AML) authentication technique. The present solution is not limited to the particulars of this example.

The securitized tokens 108 can then be used to purchase or otherwise be exchanged for collectible(s) 110 on a crypto exchange system 152. Collectibles 110 can include, but are not limited to, physical goods (for example, baseball cards, sneaker, etc.) and/or digital good(s) (for example, digital artwork). In the physical good scenario, the collectibles can be stored in a facility 124 of the crypto exchange system 152.

The CVR system 170 verifies the authenticity of the collectible(s), the ownership of the collectible(s) and/or location(s) of the collectible(s). When such verification is successful, the CVR system 170 registers the collectible(s) with the crypto exchange system 152 prior to allowing any transactions to occur therewith. A unique identifier may be assigned to each collectible during the registration process. A transaction block 126 may be added to a digital ledger 142 that includes information indicating results of the verification and the unique identifier generated for the collectible.

When an exchange 112 for a collectible and/or a securitized token occurs, one or more NFTs 116 are created on the digital ledger 142 for verifying ownership of the associated collectible and/or securitized token(s). The digital ledger 142 may be stored in a centralized and/or decentralized manner. Digital ledger 142 may be a publicly shared ledger. The digital ledger 142 may comprise blockchain 114 or be a digital ledger different from blockchain 114. Information about the exchange may also be provided from the crypto exchange system 152 to the STO system 150 as shown by arrow 122. A transaction block may be added to the blockchain 114 that includes transaction information associated with the securitized tokens 108 (for example, a change of ownership of the securitized tokens).

Each NFT 116 comprises a unique identification code and metadata that distinguishes it from other NFTs. The NFT 116 also comprises terms of the exchange 112 for the collectible 110 and/or securitized token(s). For example, the NFT can include information specifying a percentage of ownership that the individual has in the collectible. The individual may have full ownership (for example, 100%) or partial (or fractional share of) ownership (for example, 1% -N %, where N<100). The present solution is not limited to the particulars of this example. The NFT 116 may also comprise a smart contract (or code) 118 defining a main policy for access to and use of the collectible(s) and/or securitized token(s) by individual 112 and/or other individual(s) 120 (for example, a borrower of a collectible). For example, the smart contract (or code) can specify parameters for possible derivative(s) associated with the collectible(s) and/or future action(s) associated with the collectible(s) (for example, lending). The present solution is not limited in this regard.

The digital ledger(s) 114, 142 and NFTs 108 facilitate subsequent transactions 110 relating to the collectible 106 and/or securitize token(s). Information about these transactions can be stored in the digital ledger(s) 114, 142 so as to be associated with the NFTs 116. For example, transaction block(s) 126 can be added to a blockchain. The present solution is not limited to the particulars of this example. The transactions can include, but are not limited to, a change of ownership of securitized token(s), a change of ownership of collectible(s), a change of possession of collectible(s) (for example, borrowing, loaning, removal from the facility 124, or a shipping from the facility 124 to a buyer's facility), NFT trades, fractional NFT trades, and/or transactions relating to derivatives of NFTs and/or option derivatives 128 (for example, transactions in which fees are paid for the right to buy collectible(s) at its(their) current price(s) on or before an expiration date). The transactions can occur twenty-four hours all seven days of the week without physical transfer of the collectible.

The digital ledger 142 can include, but is not limited to, a chain-based ledger. The chain-based ledger can include, but is not limited to, a blockchain 130 in which transactions made between two parties are recorded chronologically in a chain of blocks 130. Each block contains a cryptographic hash of the previous block, a timestamp, and/or transaction data. In this way, the blocks cannot be altered retroactively without the alteration of all subsequent blocks and the consensus of the network.

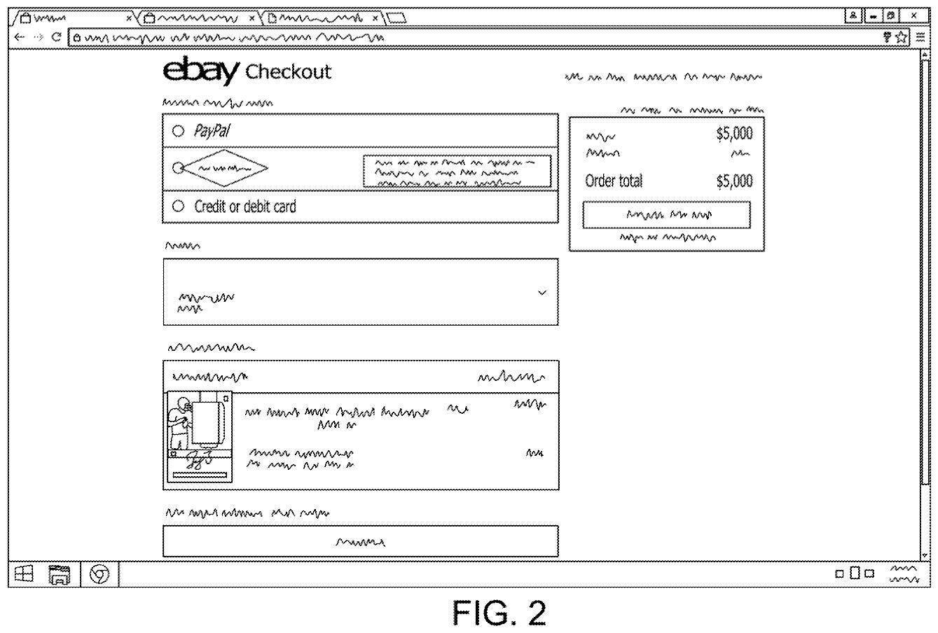

The price of each collectible 110 is variable over time. The price of each collectible is first set to an initial price determined in block 132 based on information in an index 134, historical transaction data 136 for collectibles of the same or similar type, and/or other information 138. The initial price may then be dynamically and selectively modified in block 132 based on real-time e-commerce website purchase transaction information 142 received from e-commerce system(s) 154. For example, if the collectible comprises a baseball card, then the initial price for the collectible is determined based on sale prices (for example, $3,500) for baseball cards of the same or similar quality and/or baseball cards associated with baseball players of the same or similar ranking. A similar baseball card was recently purchased during an online auction for $5,000 as shown in FIG. 2. Consequently, the price of the collectible is changed from the initial price to a second different price (for example, decreased from $3,500 to $2,500 or increased from $3,500 to $5,000) in accordance with the recent sale of the similar baseball card. The present solution is not limited to the particulars of this example. Other information can be used to set initial prices for collectibles 106 and/or vary the prices of collectibles 106, such as changes in index information 134 for collectibles of the same or similar type, specifics of securitized token purchase transactions performed in block 104 as shown by arrow 172, and/or results of operations performed by the CVR system 170 as shown by arrow 174. Price changes may also be recorded in transaction block(s) 126 of the digital ledger 112 so as to be associated with the respective NFTs 108, and/or communicated from the crypto exchange system 152 to the STO system 150 as shown by arrow 122.

In some scenarios, each NFT 116 can include information specifying a data taxonomy for pricing the respective collectible. The data taxonomy defines which data is to be used for pricing purposes. The data taxonomy can be the same as or different for the collectibles. The data taxonomy 140 could alternatively or additionally be stored in a datastore. The data taxonomy 140 is a system for categorizing data such that it is organized in a hierarchical tree from largest groupings to individual items. The data taxonomy 140 is managed by a node of the network and is modifiable as assets are removed from and added to the system.

Machine learning applications may be employed in system 100 to facilitate an exchange. The machine learning applications implement Artificial Intelligence (AI) that provides an electronic device with the ability to automatically learn and improve data analytics from experience without being explicitly programmed. The machine learning applications employ one or more machine learning algorithms that learn various information from accessed data (e.g., via pattern recognition and prediction making). Machine learning algorithms are well known in the art, and therefore will not be described herein in detail. Any known or to be known machine learning algorithm can be used herein without limitation. For example, in some scenarios, the machine learning application employs a supervised learning algorithm, an unsupervised learning algorithm, and/or a semi-supervised algorithm. Techniques for training machine learning algorithms are well known. Any known technique for training a machine learning algorithm can be used here.

The machine learning applications can be employed in, for example, blocks 104, 112, 124, 132, 142 and/or 170. Thus, the machine learning functions can be used by the STO system 150, the crypto exchange system 152, the e-commerce system 152 and/or the collectible verification and registration system 170.

The machine learning algorithms may be trained to act as research tool(s). The research tool(s) can be trained to recognize words in plaintext, identify items in images or other graphics, and/or identify patterns or trends relating to collectibles amongst individuals (e.g., auctioneers, collectors and/or general public). The research tool(s) is(are) configured to: automatically scan electronic content (e.g., news, social media posts, etc.) accessible on a network (e.g., Intranet and/or Internet) to identify different collectibles that are being discussed online and trending or popular amongst individuals (e.g., auctioneers, collectors and/or general public); output the identities of the trending or popular collectible(s) and other information associated therewith (e.g., current price, collectible type, manufacturer, current owner, being offered for sale, seller identity, collectible authenticity, etc.); and/or output information for other collectible(s) that are similar to one or more of the trending or popular collectible(s).

The research tool may cause the listed information to be presented to a user in a single Graphical User Interface (GUI). This GUI improves the underlying functionality of the system since it would present information from a plurality of sources and/or software applications in a consolidated format. In effect, a user would not need to launch a plurality of different software applications and/or access a plurality of different webpages to view data in a plurality of GUIs or windows respectively associated with the different software applications and webpages.

The machine learning algorithms may also be trained to act as a marketing tool for automations and recommendations; and/or analyze unstructured data flowing through the platform to discover insights in the collectible industry, predict trends in the collectible industry, and/or make forecasts in the collectible industry. The research tool and/or marketing tool may be configured to forecast what collectible(s) will become popular or trendy in a given time period (e.g., week(s), month(s), year(s), etc.), and make recommendations for the exchange of the same (e.g., recommend that a collectible is offered for sale now or wait a given period of time before offering the collectible for sale, and/or a recommendation to purchase a collectible of a given type within a period of time). The following information may be input into the marketing tool: outputs from the research tool; current e-commerce information for collectibles (e.g., price(s), change(s) in price(s), how long collectible(s) have been on sale, etc.); purchase transaction data; and/or historical transaction data 136.

The machine learning algorithms may be trained to act as a chatbot to facilitate quote finder and trading. The chatbot is configured to simulate conversation with human users of system 100 to, for example, complete exchanges for collectible(s) and/or option derivative(s).

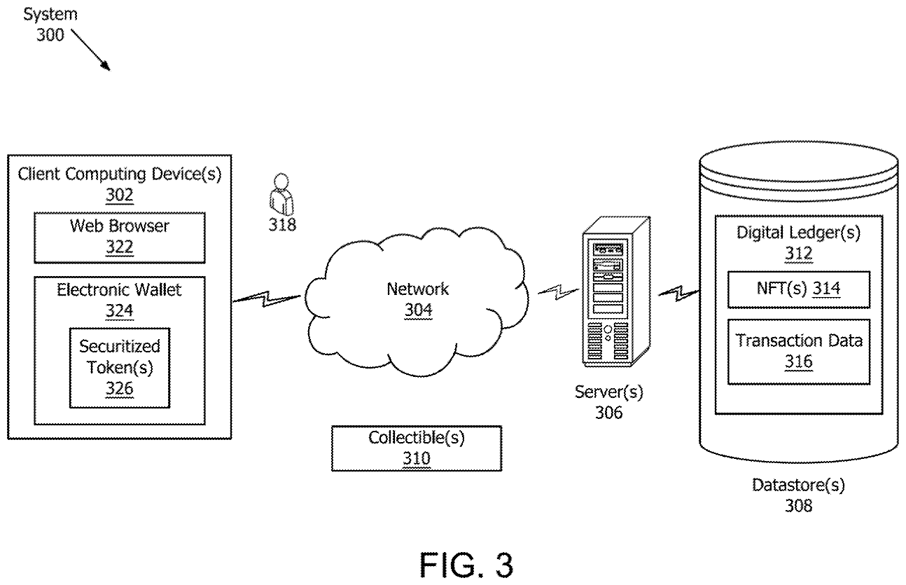

FIG. 3 provides an illustration of a system implementing the above-described novel process for exchanges relating to collectibles, NFTs and option derivatives. System 300 comprises client computing device(s) 302, sever(s) 306 and datastore(s) 308. The client computing device(s) 302 can include, but is(are) not limited to, personal computer(s), desktop computer(s), laptop computer(s), smart device(s), tablet(s) and/or personal digital assistant(s). The client computing device(s) 302 is(are) communicatively coupled to the server(s) 306 via a network 304 (e.g., the Internet or Intranet). The datastore(s) 308 can comprise a centralized storage system and/or a distributed storage system.

The server(s) 306 is(are) generally configured to facilitate creation of securitized token(s) 326 for individual(s) 316, creation of NFTs 314 for individual(s) 316, control of access to and use of the collectible(s) 310 associated with the NFTs 318 by client computing device(s) 302 and/or individual(s) 318, and facilitate transactions relating to the securitized token(s) 326, NFTs 314 and/or collectible(s) 310. The collectible(s) 310 include, but are not limited to, physical goods and/or digital goods. The digital goods can include, but are not limited to, videos, images, song recording, digital artwork, electronic documents, electronic books, electronic text-based postings (e.g., tweets), etc. Transactions relating to the collectible(s) 310 and/or securitized token(s) 326 are facilitated by digital ledger(s) 312 and the NFTs 314. The transactions can include, but are not limited to, a change of ownership of securitized token(s), a change of ownership of all or a fractional share of collectible(s), a lending/borrowing/loaning of collectible(s), a shipping of collectible(s), and/or option derivatives associated with the collectible(s).

The digital ledger(s) 312 may be implemented as chain-based ledger(s) and stored in datastore(s) 308. The chain-based ledger(s) can include, but is(are) not limited to, blockchain(s). The term “blockchain”, as used herein, refers to a digital ledger in which transactions made between two parties are recorded chronologically, efficiently and in a verifiable and permanent way. The digital ledger defines a cryptographically secure chain of blocks. Each record in the digital ledger comprises a block. Each block contains a cryptographic hash of the previous block, a timestamp, and/or transaction data. In this way, the blocks cannot be altered retroactively without the alteration of all subsequent blocks and the consensus of the network.

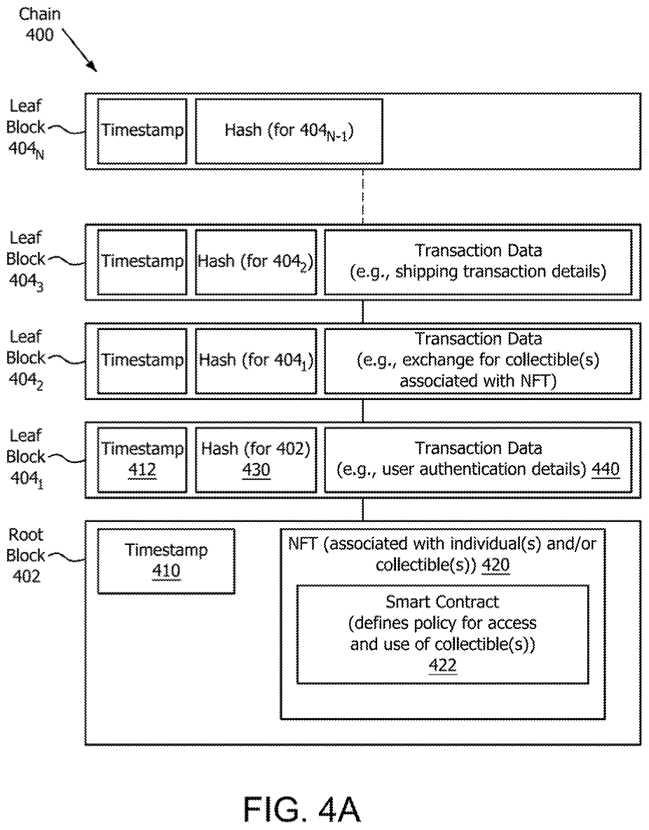

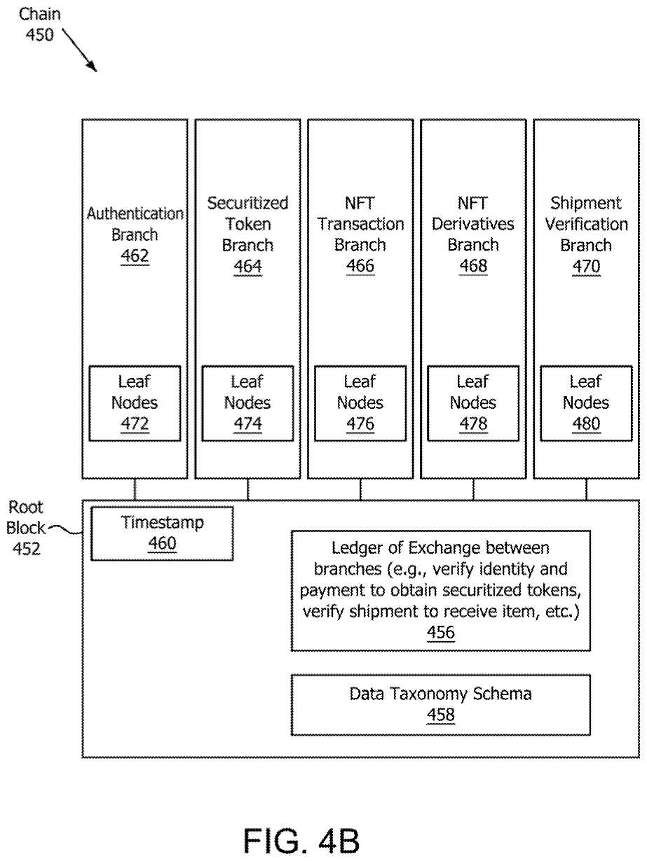

An illustrative blockchain 400 is shown in FIG. 4A. Blockchain 400 provides a digital ledger in which transactions are performed in relation to collectible(s) and/or securitized token(s) are recorded chronologically, efficiently and in a verifiable and permanent way. Blockchain 400 comprises a cryptographically secure chain of blocks. The blocks include a root block 402 and a plurality of leaf blocks 404₁, 404₂, 404₃, . . . , 404_{N} (collectively referred to as “404”), where N is an integer greater than zero.

The root block 402 comprises a timestamp 410 and an NFT 420. The timestamp 410 may include a time of a respective transaction between a client device and a server for creating the NFT and/or root block 402. The NFT 420 is associated with individual(s), collectible(s) and/or securitized token(s). The NFT 420 includes a smart contract (or code) 422 defining a policy for access to and use of collectible(s) by the individual(s) or other individual(s). For example, the policy may be that: securitized token(s) may be sold at price(s) determined in accordance with given data taxonomy(ies); collectible(s) may be sold at price(s) determined in accordance with given data taxonomy(ies); percentage of payment(s) for subsequent sale(s) of the collectible(s) is to be paid to previous owner(s) of the collectible(s); collectible(s) may be lent/borrowed/loaned for pre-defined price(s) or variable price(s) determined in accordance with a given data taxonomy; and/or option derivative(s) may be created in which a given fee is paid for the right to buy and sell the collectible(s) at its(their) current price(s) on or before a given expiration date. The present solution is not limited to the particulars of this example.

Each leaf block 404₁, 404₂, 404₃, . . . , 404_{N} provides a record of a transaction relating to collectible(s) and/or securitized token(s) associated with a given NFT 420. In this regard, each leaf block comprises a timestamp 412, a hash 430 for the previous block and transaction data 440. The timestamp 412 may include a time of the block's creation. Any known or to be known hash algorithm can be used herein without limitation to generate hashes 430 of the leaf blocks. The transaction data 440 may include, but is not limited to, securitized token identifier(s), collectible identifier(s), individual identifier(s), user permission(s), user authorization duration(s) (for example, a book can be borrowed or loaned for 3 days), instructions how to access or use resource(s), and/or specifics of transactions made by individual(s) associated with given collectible(s) and/or securitized token identifier(s).

The last leaf block 404_{N} in the chain 400 only includes a timestamp and a hash of the previous block (e.g., block 404_{N-1}). It does not originally include transaction data. Transaction data may be added to the block 404_{N} by a server when a new transaction is performed between a client device and the server. When this modification to transaction block 404_{N} occurs, a new transaction block 404_{N+1} (not shown in FIG. 4A) is created which includes the hash of transaction block 404_{N}.

Another illustrative chain 450 is shown in FIG. 4B. Chain 450 comprises a root block 452 and a plurality of branches of leaf nodes 472, 474, 476, 478, 480. The root block 452 comprises a timestamp 460 and a ledger 456 and a data taxonomy schema 458. The ledger 456 defines exchanges between the branches 462, 464, 466, 468, 470. For example, the ledger states that a user's identification must be verified prior obtaining any securitized tokens, a payment transaction must be completed prior to distribution of any securitized tokens to an individual, and/or shipment must be verified prior to receiving an item. That data taxonomy schema defines the structure of hierarchical trees for arranging in a datastore and/or accessing data stored in the datastore.

The branches include an authentication branch 462, a securitized token branch 464, an NFT transaction branch 466, an NFT derivatives branch 468, and a shipment verification branch 470. Each of the branches 462, . . . , 470 can have a similar architecture as chain 400 described above in relation to FIG. 4A. The authentication branch 462 comprises a sub-chain of leaf nodes 472 each including information relating to an authentication process for a given individual. The authentication information can include, but is not limited to, a timestamp for an authentication process, a user identifier, and results of the authentication process (for example, user identification was or was not authenticated or otherwise verified). The securitized token branch 464 comprises a sub-chain of leaf nodes 474 each including information relating to a securitized token process. The securitized token information can include, but is not limited to, a timestamp of a securitized token process, a user identifier identifying the individual that purchased the securitized token, and transaction details for the securitized token purchase. The NFT transaction branch 466 comprises a sub-chain of leaf nodes 476 each including information relating to a transaction associated with a given NFT and/or collectible associated with the NFT. The NFT derivatives branch 468 comprises a sub-chain of leaf nodes 478 each including information relating to a transaction associated with a given NFT derivative. The shipment verification branch 470 comprises a sub-chain of leaf nodes 480 each including information relating to a shipment of a given collectible from a source location to a destination location.

During a transaction process, the client device 302 executes a Web browser 322 and performs operations to log into a crypto exchange system (e.g., crypto exchange system 152 of FIG. 1). The client device 302 then communicates a request for a list of collectibles 310 that are being auctioned or otherwise offered for sale (for example, via option derivatives). The user 318 may select one or more first collectibles in the list and initiate a transaction relating thereto. Payment for the first collectible(s) 310 is facilitated by an electronic wallet 324. Securitize token(s) 326 can be used to make payment for the first collectible(s) 310 and/or other securitized token(s). Transaction data 316 is added to the digital ledger 312 when the transaction is completed. Additionally, an NFT 314 is created which is associated with the first collectible(s) and/or securitized token(s). The NFT 314 provides a means to verify ownership the collectible(s) and/or securitized token(s).

If the collectible(s) is(are) physical good(s), then the NFT 314 may be redeemed for access to the collectible(s). Once the NFT is redeemed, the collectible(s) may be shipped from a storage facility (for example, facility 124 of FIG. 1) to a destination location (for example, a home of the individual who purchased or borrowed the collectible(s)). Shipment information is added to the digital ledger 312. This allows for recoding and tracking of chain of custody for the collectible(s).

During a subsequent transaction process, another client device executes a web browser and performs operations for logging into the crypto exchange system. This transaction can include purchasing the collectible(s) from individual 318 using any form of currency, loaning the collectible(s) from individual 318, trading NFT(s) associated with second collectible(s) and/or securitized token(s) for the NFT associated with the first collectible(s) and/or securitized token(s), and/or entering into option contract(s) associated with the collectible(s) and/or securitized token(s).

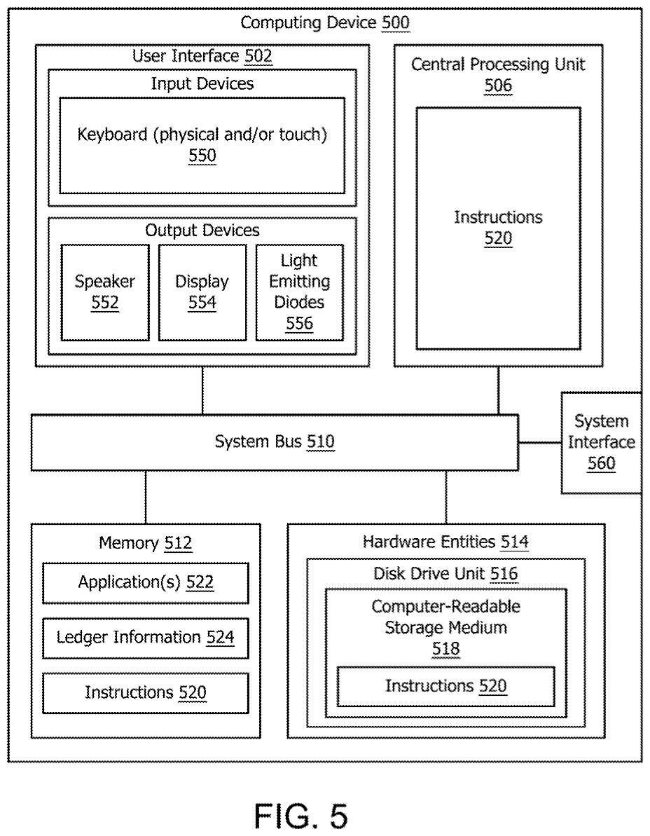

Referring now to FIG. 5, there is provided an illustration of an architecture for a computing device 500. STO system 150, crypto exchange system 152 and/or e-commerce system 154 of FIG. 1 may be implemented by one or more computing device(s) 500. Client computing device(s) 302 and/or server(s) 306 of FIG. 3 is(are) the same as or similar to computing device 500. As such, the discussion of computing device 500 is sufficient for understanding these components of systems 100, 300.

In some scenarios, the present solution is used in a client-server architecture. Accordingly, the computing device architecture shown in FIG. 5 is sufficient for understanding the particulars of client computing devices and servers.

Computing device 500 may include more or less components than those shown in FIG. 5. However, the components shown are sufficient to disclose an illustrative solution implementing the present solution. The hardware architecture of FIG. 5 represents one implementation of a representative computing device configured to provide an improved item return process, as described herein. As such, the computing device 500 of FIG. 5 implements at least a portion of the method(s) described herein.

Some or all components of the computing device 500 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 5, the computing device 500 comprises a user interface 502, a Central Processing Unit (CPU) 506, a system bus 510, a memory 512 connected to and accessible by other portions of computing device 500 through system bus 510, a system interface 560, and hardware entities 514 connected to system bus 510. The user interface can include input devices and output devices, which facilitate user-software interactions for controlling operations of the computing device 500. The input devices include, but are not limited, a physical and/or touch keyboard 550. The input devices can be connected to the computing device 500 via a wired or wireless connection (e.g., a Bluetooth® connection). The output devices include, but are not limited to, a speaker 552, a display 554, and/or light emitting diodes 556. System interface 560 is configured to facilitate wired or wireless communications to and from external devices (e.g., network nodes such as access points, etc.).

At least some of the hardware entities 514 perform actions involving access to and use of memory 512, which can be a Random Access Memory (RAM), a solid-state or disk driver and/or a Compact Disc Read Only Memory (CD-ROM). Hardware entities 514 can include a disk drive unit 516 comprising a computer-readable storage medium 518 on which is stored one or more sets of instructions 520 (e.g., software code) configured to implement one or more of the methodologies, procedures, or functions described herein. The instructions 420 can also reside, completely or at least partially, within the memory 512 and/or within the CPU 506 during execution thereof by the computing device 500. The memory 512 and the CPU 506 also can constitute machine-readable media. The term “machine-readable media”, as used here, refers to a single medium or multiple media (e.g., a centralized or distributed database, and/or associated caches and servers) that store the one or more sets of instructions 520. The term “machine-readable media”, as used here, also refers to any medium that is capable of storing, encoding or carrying a set of instructions 520 for execution by the computing device 500 and that cause the computing device 500 to perform any one or more of the methodologies of the present disclosure.

Computing device 500 implements chain-based technology. In this regard, computing device 500 runs one or more software applications 522 for facilitating: the completion of transactions or exchanges relating to collectible(s) (for example, collectible(s) 110 of FIGS. 1 and/or 310 of FIG. 3); the creation of securitized tokens (for example, securitized tokens 108 of FIGS. 1 and/or 326 of FIG. 3); the use of securitized tokens to complete transactions or exchanges; the creation of NFTs (for example, NFTs 116 of FIGS. 1 and/or 314 of FIG. 3); the trading of NFTs; the creation of option derivatives; the completion of transactions involving the option derivatives; and/or the creation of digital ledger(s) (for example, digital ledgers 114, 142 of FIG. 1, 312 of FIG. 3, chain 400 of FIG. 4A, and/or chain 450 of FIG. 4B). Other operations and/or functions of software applications 522 are evident from other portions of this document. The present solution is not limited to the particulars of this example.

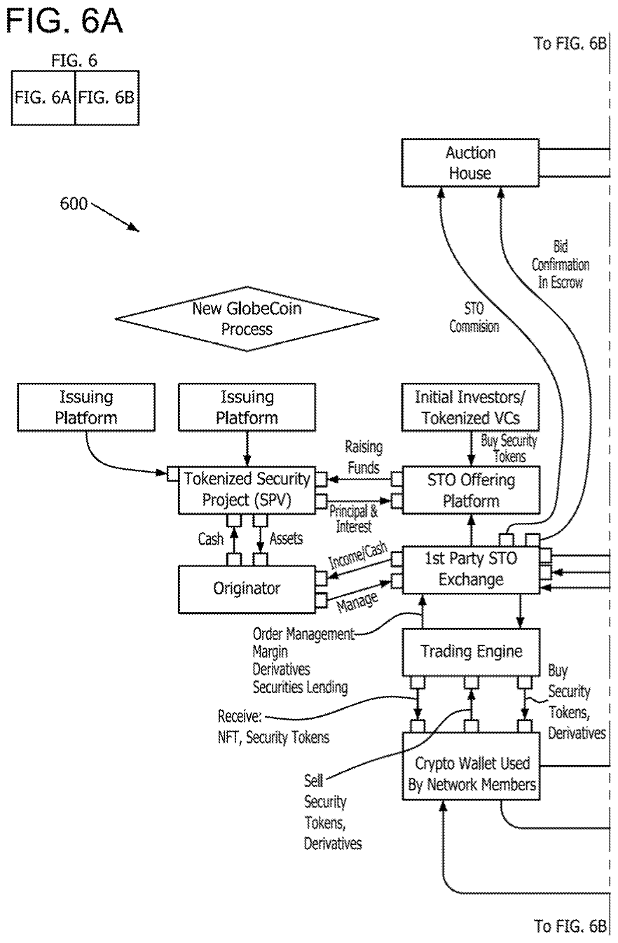

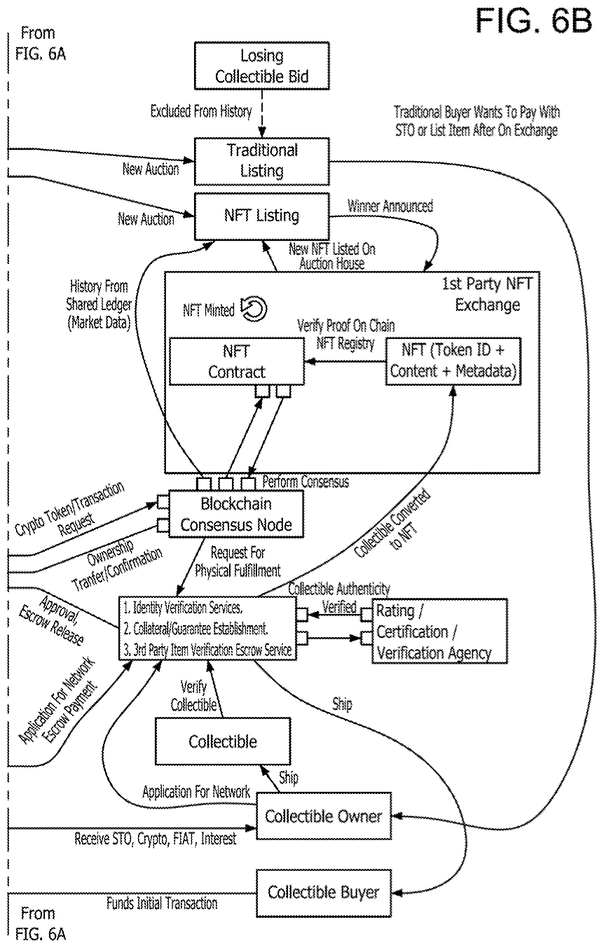

Referring now to FIG. 6, there is provided a more detailed illustration of a system 600 implementing the present solution. System 600 is configured to facilitate creation of an exchange on top of a securitized token which is backed in-turn by a dependent series of assets that eventually resolve to a physical collectible. Such an exchange may, for example, be of the type that is registered pursuant to the Securities Exchange Act of 1964 and the rules promulgated thereunder by the SEC.

In a traditional futures market backed by physical assets, physical assets (such as cattle or wheat) are offered on a standardized terms structure of rolling calendarized contracts, with derivative options offered on top of these same contracts. Each asset is exercisable until eventual physical delivery of the asset. Each asset can be purchased with fiat currency as well.

Unlike the traditional futures market, in system 600, all currency must first be converted into securitized token(s), whose value is backed through the offering of corporate shares as well as the collectibles on which the rest of the system derivatives are traded on top of. These collectibles are securitized and tokenized into NFTs or other digital assets that verify the ownership of the collectible(s). The ownership and transfer of the collectible(s) and/or NFTs are tracked on a shared ledger. Exchanges are only made possible through a network consensus approving each transaction.

As the NFTs are immutable and may be linked to delivery of physical collectible(s), and since the NFTs are backed by the securitized token(s) which in turn has backing by corporate shares and collectibles, when transactions are processed through proof of stake, they can always be exercised for physical cards guaranteed by the network.

Fractional NFTs and option derivatives are then able to be traded and exercised for the NFTs, thereby offering liquidity even when auctions of rare collectibles happen rarely. This liquidity comes from the fact the NFTs, fractional NFTs, and option derivatives are able to be traded 24/7 in real time without physical transfer of the collectible(s). Thus, pricing is established for future auctions without collectibles having to change hands physically nor auctions actually having to complete before price changes are seen.

The entities of system 600 work together to codify legal obligations with smart contracts that are then in turn sent to an STO offering platform. As shown, a Special Purpose Vehicle (SPV), which the illustration describes as a “Tokenized Security Project SPV”, may be utilized to encapsulate transactions of funds and principal/interests to/from the STO offering platform. SPV exchanges regulate shares of the STO offering platform through regulatory exemption (Reg A+, Reg D, Reg S) for ERC20 and/or native tokens (which are fungible). An originator originates STO assets (including both collectibles & corporate shares) which are held and managed by this entity and exchanged for currency with the SPV and the STO offering platform.

The components of system 600 have the following responsibilities: enforcing compliance with policies (stored on the blockchain as a part of the publicly available shared ledger); KYC and AML for all investors and traders who would want to access the network and perform transactions of any kind (stored on the blockchain as a part of the publicly available shared ledger); legal obligations related to offering digital asset custody to investors; maintaining of immutable transaction history; maintaining a dynamic cap table (stored on the blockchain as a part of the publicly available shared ledger); automating settlement; and/or automatically and tracking transfers of the STO offering platform.

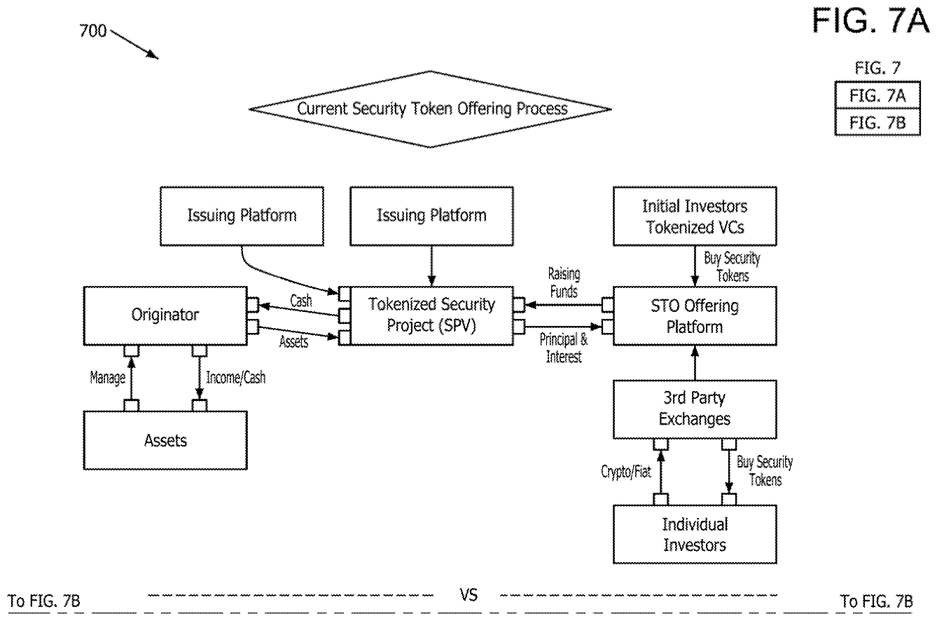

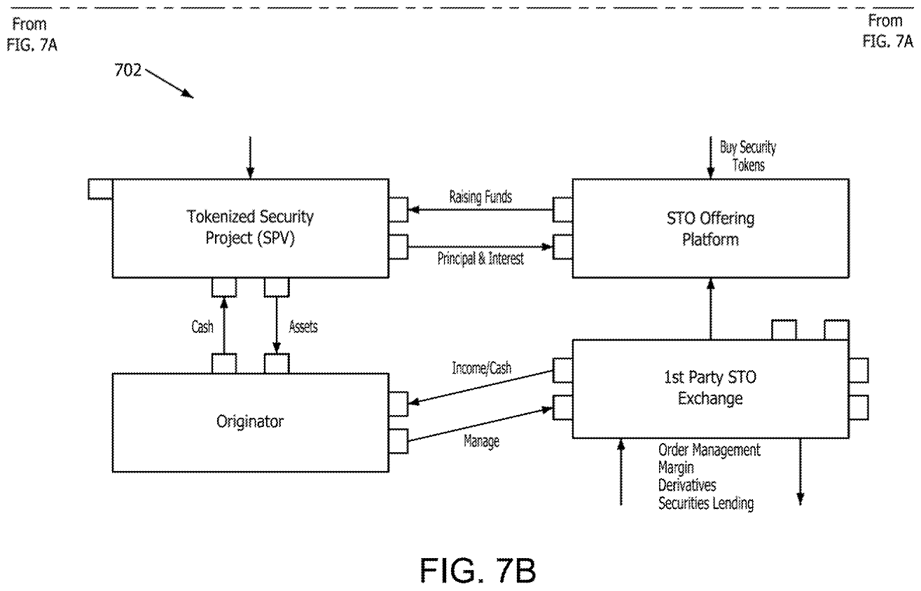

FIG. 7 provides an illustration that is useful for understanding differences of the present solution 702 implemented by system 600 from current STO offering processes 700. In the current STO offering processes 700, the value of the originator's assets is not tied to a third party. In contrast, the originator's assets are offered by the present solution 702 through auctions and exchange-related trading managed by exchange offering derivatives on NFTs. Thus, unlike the conventional scheme 700, the present solution 702 involves continuously and dynamically adjusting prices for securitized token assets based on exchange activities (for example, auctions, exercises of option derivatives, etc.). Novelly, this means the originator in system 600 must dynamically re-price the value of held assets and report them to the SPV based upon exchange activity.

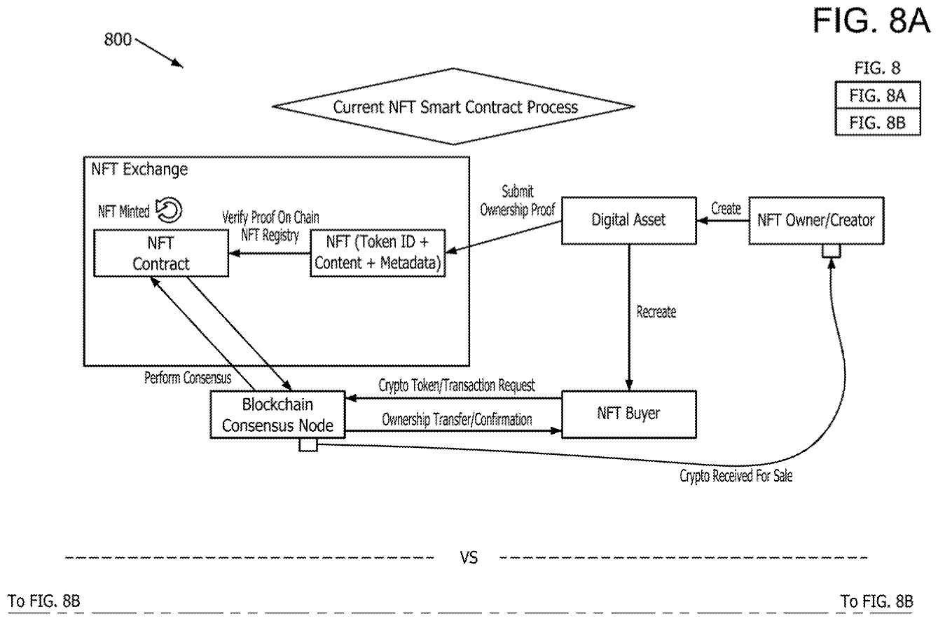

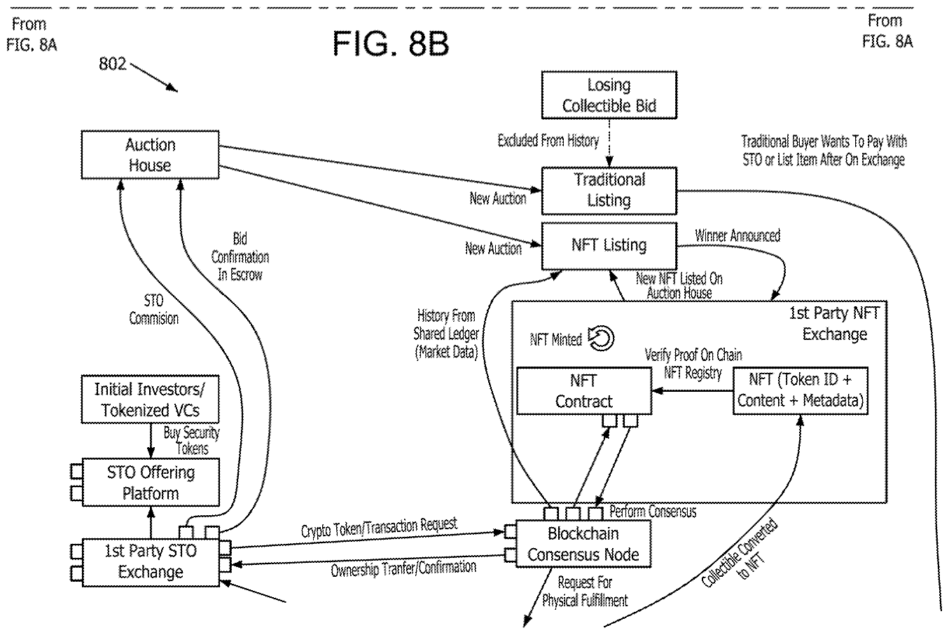

FIG. 8 provides an illustration that is useful for understanding how a smart contract process 802 of system 600 differs from conventional smart contract processes 800. The current process 800 by which NFTs are transacted are notably different than in system 600. In the commonly accepted NFT smart contract exchange process, primarily digital assets are submitted to a NFT exchange for minting (creation) and then through consensus transactions allow these NFTs to be bought and sold for non-linked cryptocurrencies (such as Bitcoin). This is not the case in process 802. Instead, in process 802, NFTs are immutably linked to valid transactions performed for the project securitized token in third party collectible auction houses, and thus these auctions are required to mint the NFTs traded within the system.

Shipment of the item through third party shipping providers is tracked through network consensus tied to the NFT as well, establishing that all physical custody is immutably stored on the network. As third-party shipping providers provide digital tracking, these tracking updates can be encoded into the ledger and attached to the NFT's history, thus linking custody and transit to each item.

A Hyper Text Markup Language (HTML)/Cascading Style Sheet (CSS)/Java Script (JS) and Application Programming Interface (API) widget and Software Development Kit (SDK) may be licensed to third party auction houses to allow for collectibles to be bid upon and purchased through the securitized token of the network. Through a contractual relationship with the auction house, the collectible is then transferred to the originator/originator licensed escrow service which provides identity verification services on the buyer, seller, and the collectible to ensure that the collectible is as stated in the auction. This includes verification with external third-party ratings/certification/verification agencies APIs whose ratings are encoded within the NFT as a part of the minting process.

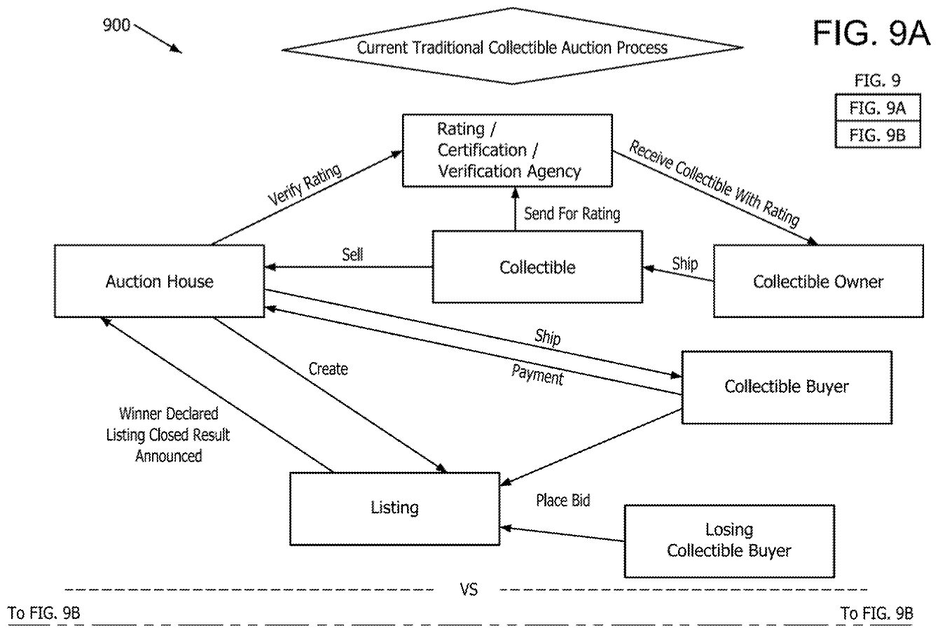

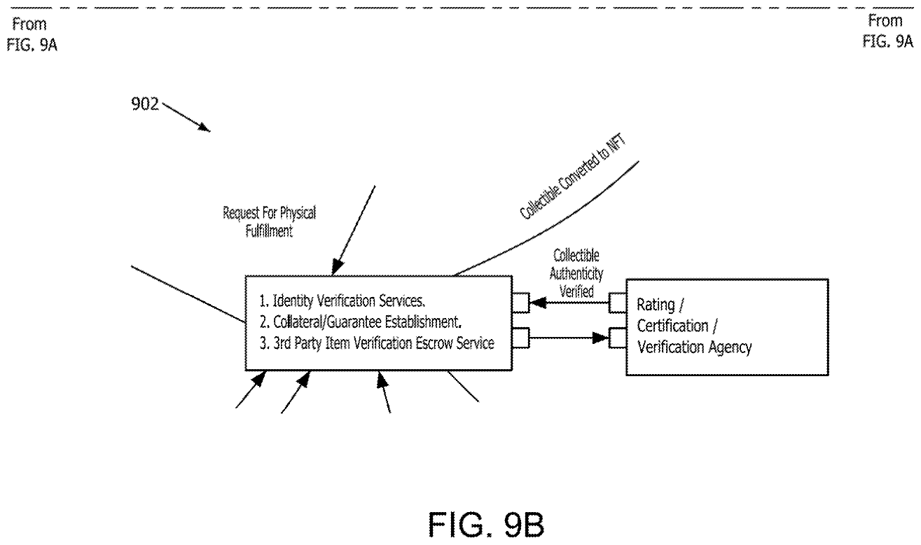

FIG. 9 provides an illustration that is useful for understanding differences between an auction process 902 of the system 600 and a conventional auction process 900. The conventional auction process 900 does not involve storage of shipment verification, collectible verification, or buyer/seller due diligence on a shared ledger. Thus, these processes are not publicly available for review and their entire responsibility falls on an auction house. In the present systems, the collectible verification system (170 on FIG. 1) represents authentic collectibles as registered entities in the shared ledger, thus enabling verification of the collectibles in future transactions.

These processes are now publicly available and only able to be established through consensus by the network in system 600 via auction process 902. This means that, until proof of shipment, verification and item verification are processed transparently, the network transactions are not able to be processed and tokens are not able to be released from escrow.

The nature of the present solution being backed by rare collectibles dictates that, instead of assets resolving to interoperable units (for example, a barrel of oil), the base component is always tied eventually to a unique auction listing (for example, a specific physical baseball card). Dependently then, a data system taxonomy exists to standardize these unique listings into indexable groupings. These groupings allow price indexes to be generated across multiple unique listings. Where, up until the end of the data taxonomy, further description can be omitted, and an index of the collectibles is generated as a unique derivative. For example, leaving off all aspects of data taxonomy past Type would be a tradeable index of all collectibles having the same identifier. The present solution is not limited to the particulars of this example.

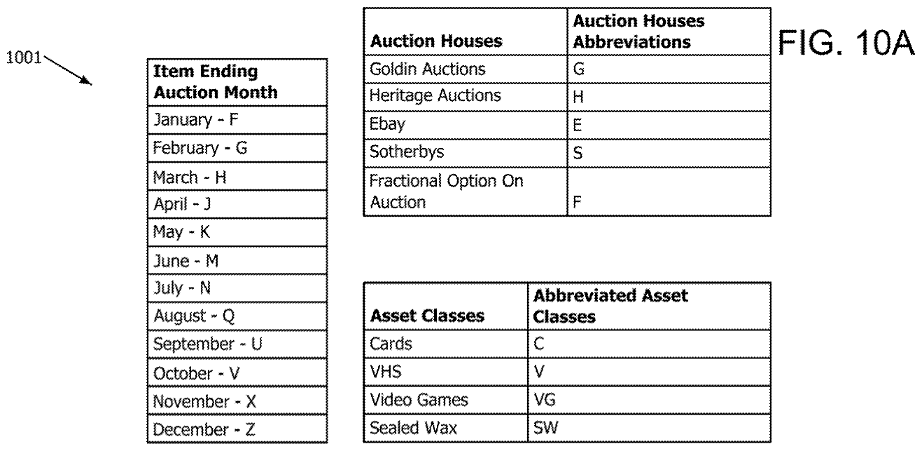

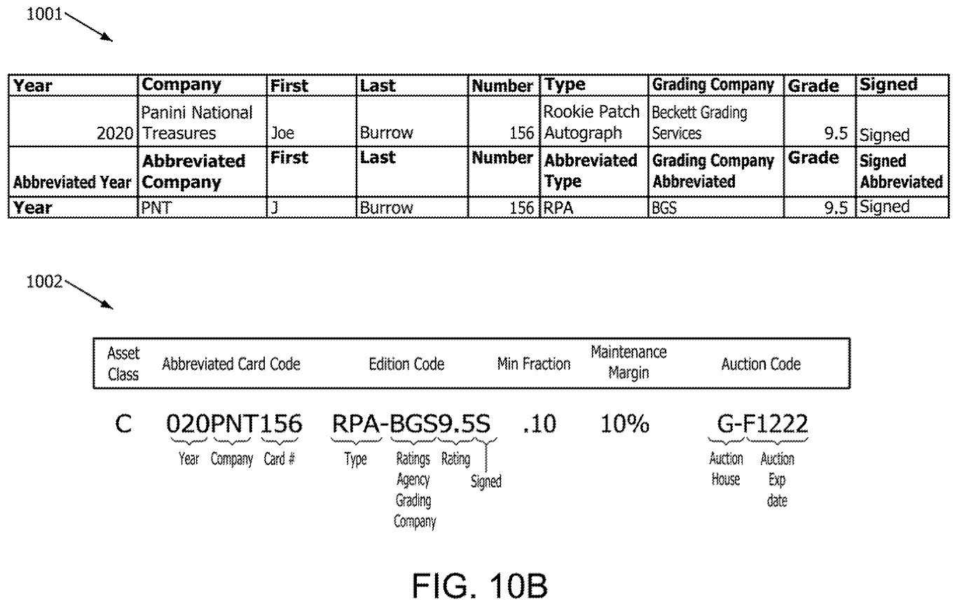

In some scenarios, a data taxonomy is defined by a plurality of information. The data taxonomy generally organizes different platform assets into a self-describing symbology making it easy to standardize categorization of all collectible types and their sub-assets. This standardization makes it possible to compare asset prices and differentiated components of them in a transparent way. This information defining the data taxonomy includes, but is not limited to, an asset class (for example, cards, memorabilia, video home system tapes, cassettes, games, art, ticket stubs, action figures, etc.), a year of creation, a company (for example, which made collectible), a unique identifier, a type (for example, custom attributes such as rookie, holographic, etc.) which define the collectible more specifically than a unique identifier, a rating/verification agency classification, a fractionalization exchange offering indicator, an origin auction house identifier, and/or a listing expiration date. An illustration is provided in FIG. 10 that is useful for understanding an example data taxonomy 1001 with data elements such as those described above. The data taxonomy 1001 may be implemented as a plurality of tables. For example, as shown in FIG. 10A, a first table can be provided for item ending auction months and associated codes. A second table can be provided for auction houses and associated codes. A third table can be provided for asset classes and associated codes. In addition, FIG. 10 shows a data string 1002 that represents a particular collectible. The data string includes data elements such as an asset class code, an item code (i.e., a unique identifier for the item”), an edition code (representing a group of collectibles that include the specific collectible item), a minimum fractional amount of an associated derivative, option or NFT that purchasers may acquire, a seller code that may identify the seller and/or a location when or where the sale will occur (such as at an auction), and/or other data such as a margin amount that is paid to the seller and/or the owner of the underlying collectible. Other data elements may be included.

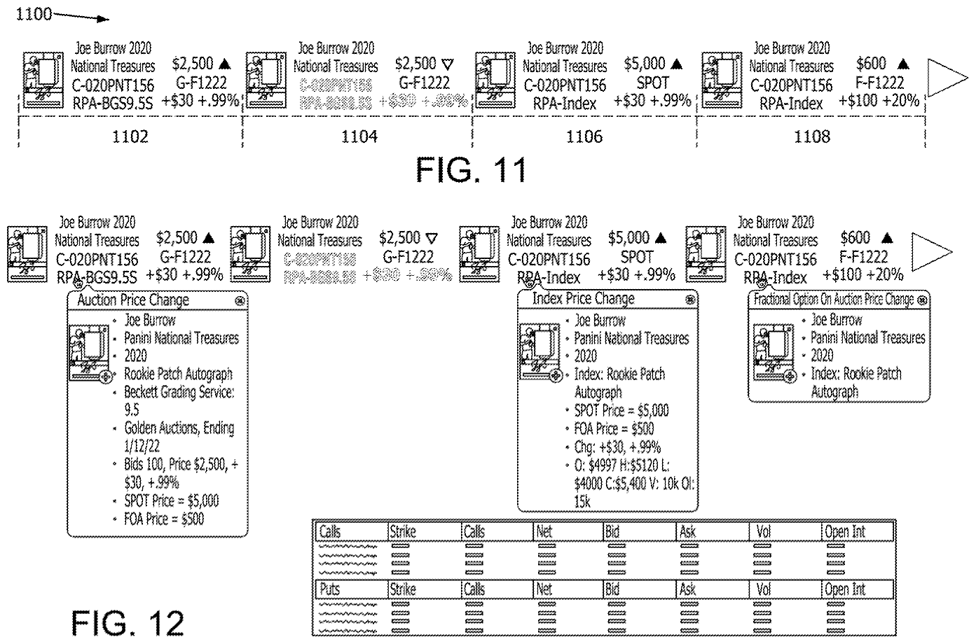

Through the indexing derivative system described above, a quote can be generated at any level of the data taxonomy. These quotes can be displayed through a ticker, streaming chart, historical chart, order book, depth of market chart, and/or heatmap displaying the data taxonomy at any level of specificity. An illustrative ticker GUI 1100 is shown in FIG. 11. The ticker GUI 1100 allows a user to see streaming quotes for auction collectibles, NFTs and/or derivatives in one place. This ability to see liquid price updates provides a source of accurate price information even on scarce collectibles with low auction volume. Ticker interface 1100 shows quotes 1102, 1104 for two specific NFT-backed auction listings, an index 1106 on the NFTs that back the specific collectible across all ratings/verifications, and a quote 1108 showing how a fractional NFT of the same index could receive its own price. A user can interact with the ticker interface 1100 to drill down on specific item listings and indexes as shown in FIG. 12. This drill down feature allows metadata on the market data and item to be displayed together in real time or near real time. The present solution is not limited to the metadata shown in FIG. 12. The metadata may include, but is not limited to, an auction price change for a collectible, a fractional option on auction price change, and/or an index price change.

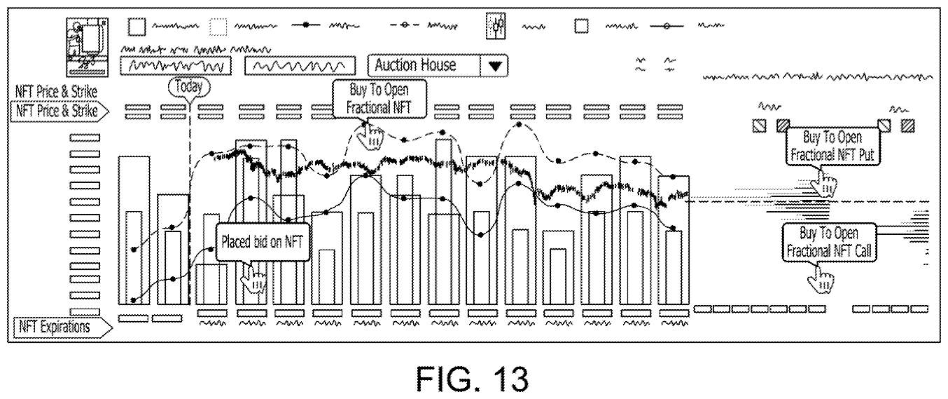

The data taxonomy also allows for market data to be viewed at multiple levels simultaneously, in real time, as shown in FIG. 13. Underlying auctions at different expirations can be aggregated, and derivative NFTs, fractional NFTs and options can thus all have pricing, volume and open interest tied to each other. As the data taxonomy is further specified, the indexing becomes narrower, until landing on the specific collectible item. These integrated components of increasing liquidity can serve as a point to execute orders on-top of the interface. The information also provides an assessment of an expected value of the underlying physical collectible, as the total of all interests purchased in the registered digital assets associated with the collectible can serve as in indicator of a likely selling price of the collectible itself.

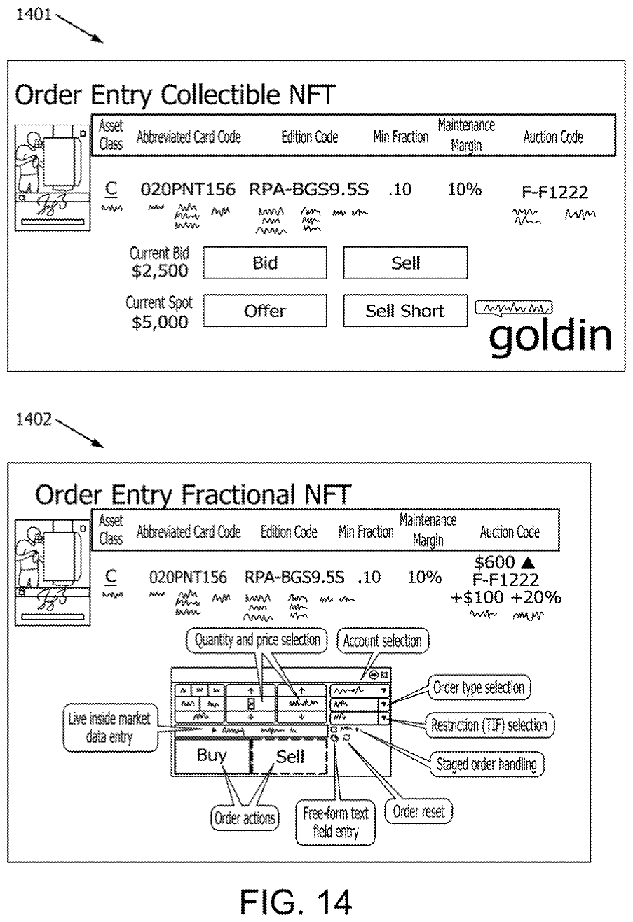

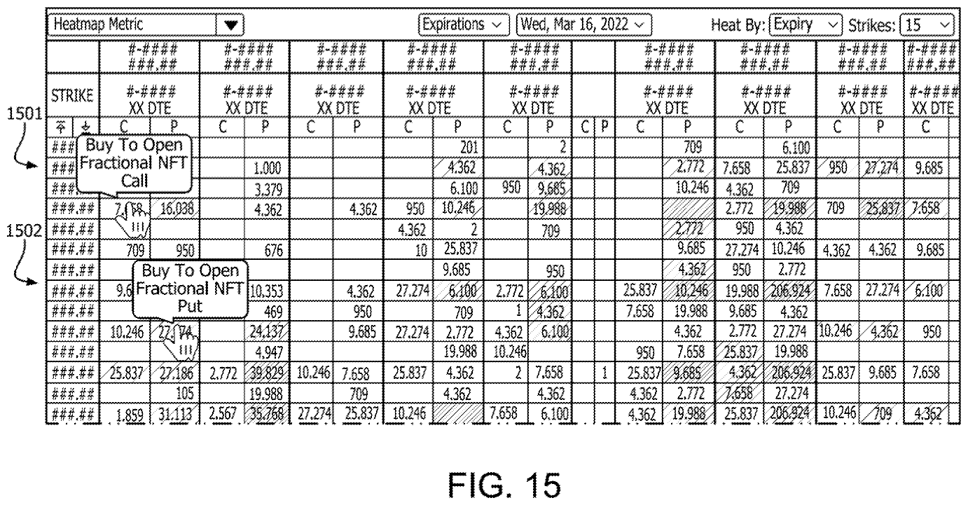

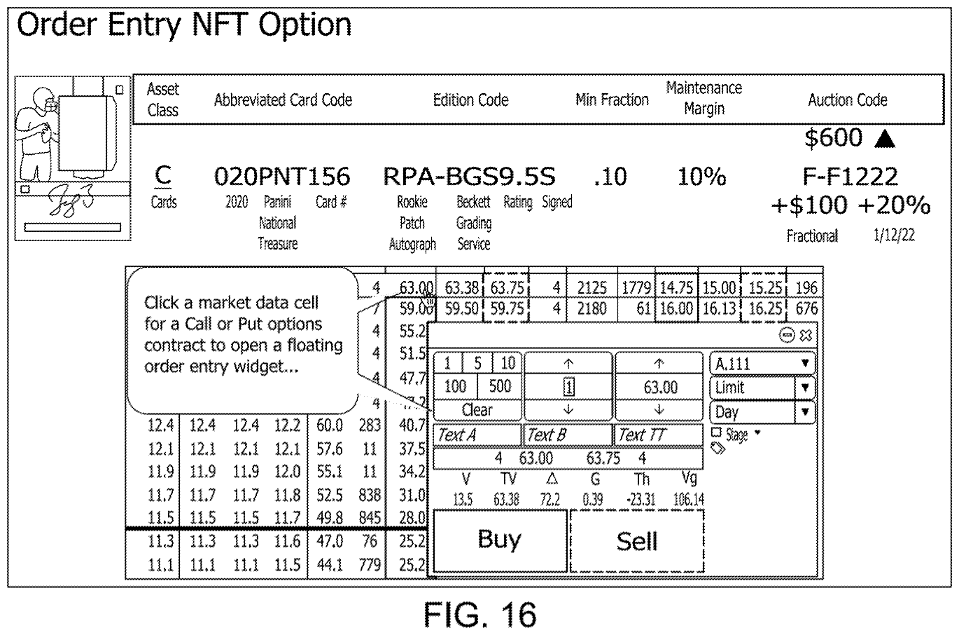

Triggering order entry at each level of liquidity and indexing shows a different order entry capability, adapting to the nature of the underlying instrument. For instance, as shown in FIGS. 14-15, the system enables viewing data on a full NFT relating to the collectible 1401, fractional NFTs relating to the collectible 1402, and/or other instruments such as options and derivatives of the NFTs. Clicking on the price or other displayed information associated with collectible-backed NFT 1501 allows for bidding directly onto the NFT listing, whereas clicking on information relating to the fractional NFT 1502 would initiate a trade on the fractional NFT. If clicking on the option at a given price-level, an option order entry panel can also be utilized as shown in FIG. 16. Notice how the options contracts are tied uniquely both to the expiration schedule of NFT auctions as well as differing price levels.

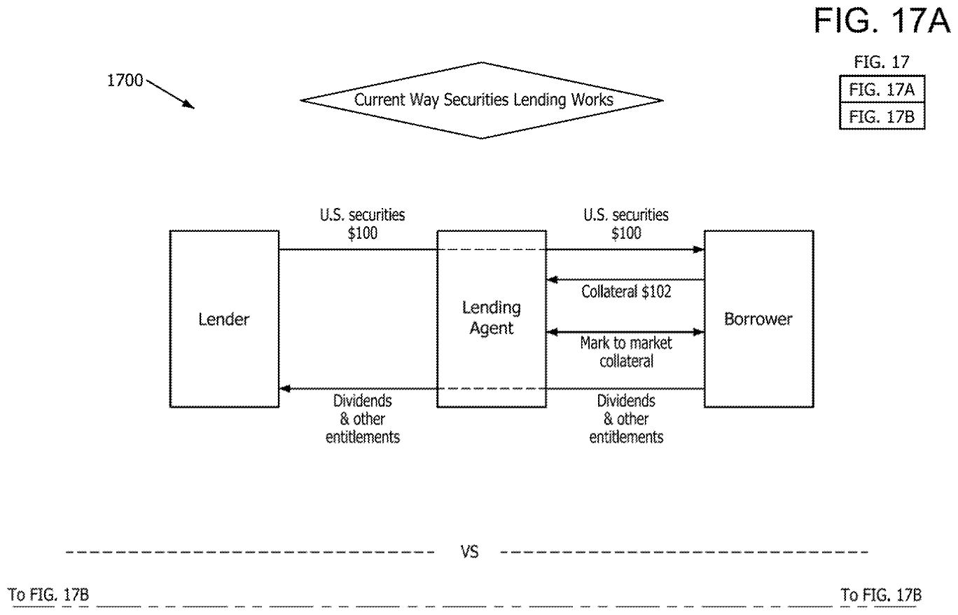

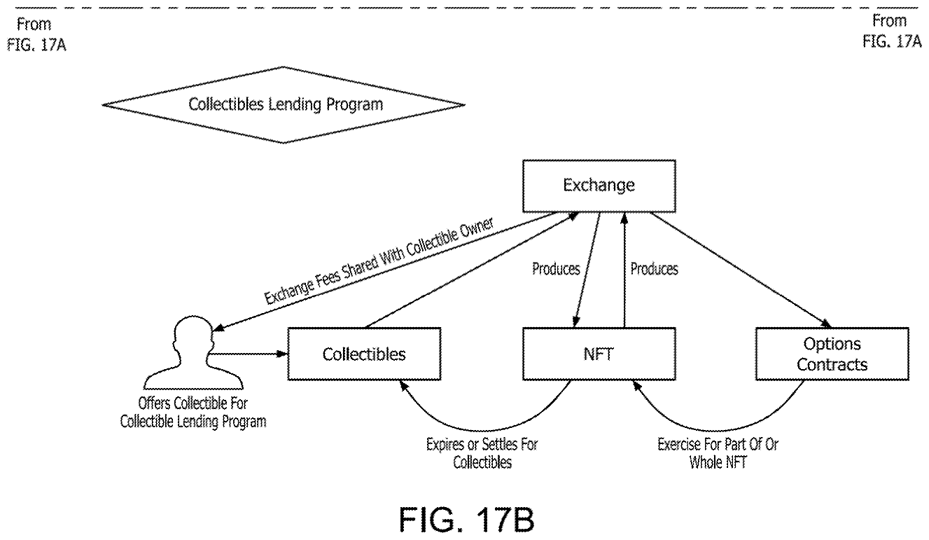

FIG. 17 provides an illustration that is useful for understanding differences between a collectible lending process 1702 of system 600 and a conventional securities lending process 1700. Margin and short interest are offered in system 600 to back shorting and derivatives trading. To back these transactions, users can offer their collectibles to system 600 through a lending program. The lending origination system backing the collectibles lending program differs from traditional securities lending in that instead of a lending agent producing dividends and other entitlements, it is settlement of the collectible from NFT and options trading through the crypto exchange that generates exchange fees for the collectible owner. In essence, this means that the collectibles owner is staking the network's securitized token, NFTs and derivatives on top of these NFTs with a physical collectible. As they are providing asset verification for the network consensus, they are rewarded with additional securitized tokens for their efforts to support the network.

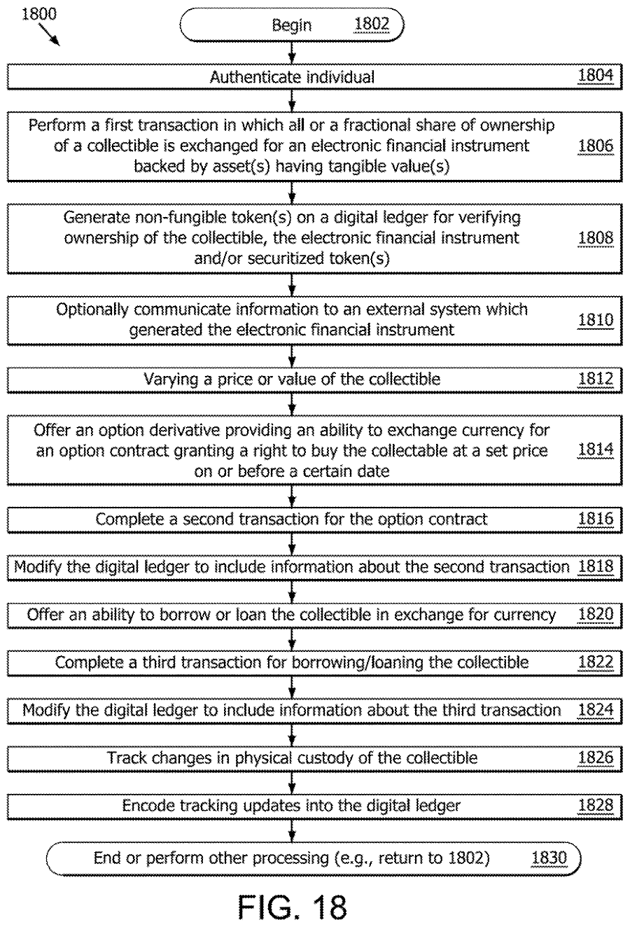

Referring now to FIG. 18, there is provided a flow diagram of an illustrative method 1800 for providing an online exchange system (for example, system 100 of FIG. 1, crypto exchange system 152 of FIG. 1, system 300 of FIG. 3 and/or system 600 of FIG. 6). The online exchange system is generally configured to facilitate exchanges relating to collectible(s) (for example, collectible(s) 110 of FIGS. 1 and/or 310 of FIG. 3).

Method 1800 begins with 1802 and continues with 1804 where a computing device (for example, server(s) 306 of FIG. 1 and/or computing device 500 of FIG. 5) performs operations to authenticate an identity of an individual prior to allowing the individual access to the online exchange system. Any known or to be known authentication technique can be used here.

In 1806, the computing device performs a first transaction in which all or a fractional share of an ownership of a collectible is exchanged for an electronic financial instrument backed by asset(s) having tangible value(s). The electronic financial instrument can include, but is not limited to, a securitized token (for example, securitized token 108 of FIG. 1 or 326 of FIG. 3). In this case, the external system comprises a security token offering system (for example, STO system 150 of FIG. 1). The asset(s) can include, but is(are) not limited to, unit(s) of equity ownership in a corporation (for example, corporate share(s)) and/or collectible(s).

In 1808, the computing device generates NFT(s) (for example, NFT 116 of FIG. 1 or 314 of FIG. 3) on a digital ledger (for example, 142 of FIG. 1 or 312 of FIG. 3) for verifying ownership of the collectible, the electronic financial instrument and/or securitized token(s). The computing device may optionally communicate information to an external system (for example, STO system 150 of FIG. 1) which generated the electronic financial instrument. This communication causes a block is be added to another digital ledger (for example, digital ledger 114 of FIG. 1) that indicates a change of ownership of the electronic financial instrument occurred during the first transaction.

The price or value of the collectible may be varied in 1812. The price/value variation can be based on an index (for example, index 134 of FIG. 1, historical transaction data (for example, data 136 of FIG. 1) and/or purchase transaction data (for example, data 142 of FIG. 1) received from other online exchange system(s) (for example, e-commerce system 154 of FIG. 1). Changes to the price can occur in real time or near real time as transactions are completed via the other online exchange systems.

In 1814, the online exchange system offers an option derivative providing an ability to exchange currency for an option contract granting a right to buy the collectible at a set price on or before a certain date. The terms of the option contract may be set in accordance with a policy defined in the NFT. A second transaction is completed in 1816 whereby the currency is exchanged for the option contract. The digital ledger is modified in 1818 to include information specifying details of the second transaction.

In 1820, the online exchange system offers an ability to borrow or loan the collectible in exchange for currency. The terms of the option may be set in accordance with a policy defined in the NFT. A third transaction is completed in 1822 for borrowing or loaning the collectible. The digital ledger may be modified in 1824 to include information specifying details of the third transaction.

In 1826, the online exchange system performs operations to track changes in physical custody of the collectible. Tracking updates are encoded into the digital ledger so as to be tied to transaction history of the NFT associated with the collectible, as shown by 1828. Subsequently, 1830 is performed where method 1800 ends or other processing is performed (e.g., return to 1802).

Method 1800 is not limited to the operations described above. Method 1800 may additionally or alternatively comprise: generating and presenting a single graphical user interface simultaneously displaying streaming quotes for auctioned collectibles, non-functional tokens and derivatives; organizing assets of a plurality of different platforms in accordance with a data taxonomy that is defined by at least one of an asset class, a year of creation of a collectible, a company that made the collectible, a unique identifier for the collectible, a collectible type, a rating or verification agency classification, a fractionalization exchange offering indicator, an origin auction house identifier, and a listing expiration date; and/or using artificial intelligence or machine learning algorithm(s) to: (i) automatedly identify patterns or trends relating to collectibles amongst individuals based on electronic content accessible on a network; (ii) discover insights, predict trends and/or make forecasts in the collectible industry based on unstructured data flowing through the online exchange system; (iii) make recommendations for the exchange of collectibles based on the patterns or trends relating to collectibles and/or historical transaction data; or (iv) provide a chatbot configured to simulate conversation with individuals for facilitating trading. These additional or alternative operations could, for example, be performed in block 1830.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above-described embodiments. Rather, the scope of the present solution should be defined in accordance with the following claims and their equivalents.

What is claimed is:

1. A method for providing an online exchange system, comprising:
performing, by a computing device of the online exchange system, a first transaction in which an ownership of a collectible is exchanged for an electronic financial instrument backed by at least one asset having a tangible value;
generating, by the computing device, a non-fungible token on a first digital ledger for verifying ownership of the collectible; and
communicating information from the computing device to a system which generated the electronic financial instrument such that a block is added to a second digital ledger that indicates a change of ownership of the electronic financial instrument occurred during the first transaction.

2. The method according to claim 1, wherein the first and second digital ledgers are the same digital ledger.

3. The method according to claim 1, wherein the first and second digital ledgers are different digital ledgers.

4. The method according to claim 1, wherein the electronic financial instrument comprises a securitized token and the system comprises a security token offering system.

5. The method according to claim 1, wherein the at least one asset comprises at least one unit of equity ownership in a corporation.

6. The method according to claim 1, wherein a fractional share of ownership in the collectible was exchanged for the electronic financial instrument during the first transaction.

7. The method according to claim 1, further comprising offering, by the online exchange system, an ability to exchange currency for an option contract granting a right to buy the collectible at a set price on or before a certain date.

8. The method according to claim 7, wherein the terms of the option contract being set in accordance with a policy defined in the non-fungible token.

9. The method according to claim 7, further comprising completing, by the computing device, a second transaction in which the currency is exchanged for the option contract.

10. The method according to claim 9, further comprising performing operations by the computing device to modify the first digital ledger to include information specifying details of the second transaction.

11. The method according to claim 1, further comprising offering, by the online exchange system, an ability to borrow or loan the collectible in exchange for currency in accordance with a policy defined in the non-fungible token.

12. The method according to claim 11, further comprising performing operations by the computing device to complete a third transaction for borrowing or loaning the collectible and modifying the first digital ledger to include information specifying details of the third transaction.

13. The method according to claim 1, further comprising continuously varying a price of the collectible based on an index, historical transaction data, and purchase transaction data received from other online exchange systems.

14. The method according to claim 1, further comprising tracking changes in physical custody of the collectible and encoding tracking updates into the first digital ledger so as to be tied to transaction history of the non-fungible token.

15. The method according to claim 1, further comprising authenticating an identity of an individual prior to allowing the individual access to the online exchange system.

16. The method according to claim 1, wherein the non-fungible token is configured to verify ownership of one or more securitized tokens in addition to the ownership of the collectible.

17. The method according to claim 1, further comprising generating and presenting a single graphical user interface simultaneously displaying streaming quotes for auctioned collectibles, non-functional tokens and derivatives.

18. The method according to claim 1, further comprising organizing assets of a plurality of different platforms in accordance with a data taxonomy that is defined by at least one of an asset class, a year of creation of a collectible, a company that made the collectible, a unique identifier for the collectible, a collectible type, a rating or verification agency classification, a fractionalization exchange offering indicator, an origin auction house identifier, and a listing expiration date.

19. The method according to claim 1, further comprising using artificial intelligence or a machine learning algorithm to: (i) automatedly identify patterns or trends relating to collectibles amongst individuals based on electronic content accessible on a network; (ii) discover insights, predict trends and/or make forecasts in the collectible industry based on unstructured data flowing through the online exchange system; (iii) make recommendations for the exchange of collectibles based on the patterns or trends relating to collectibles and/or historical transaction data; or (iv) provide a chatbot configured to simulate conversation with individuals for facilitating trading.

20. A system, comprising:
a processor;
a non-transitory computer-readable storage medium comprising programming instructions that are configured to cause the processor to implement a method for providing an online exchange system, wherein the programming instructions comprise instructions to:
perform a first transaction in which an ownership of a collectible is exchanged for an electronic financial instrument backed by at least one asset having a tangible value;
generate a non-fungible token on a first digital ledger for verifying ownership of the collectible; and
communicate information from the computing device to a system which generated the electronic financial instrument such that a block is added to a second digital ledger that indicates a change of ownership of the electronic financial instrument occurred during the first transaction.

21. The system according to claim 20, wherein the first and second digital ledgers are the same digital ledger.

22. The system according to claim 20, wherein the first and second digital ledgers are different digital ledgers.

23. The system according to claim 20, wherein the electronic financial instrument comprise a securitized token and the system comprises a security token offering system.

24. The system according to claim 20, wherein the at least one asset comprises at least one unit of equity ownership in a corporation.

25. The system according to claim 20, wherein a fractional share of ownership in the collectible was exchanged for the electronic financial instrument during the first transaction.

26. The system according to claim 20, wherein the programming instructions further comprise instructions to offer an ability to exchange currency for an option contract granting a right to buy the collectible at a set price on or before a certain date.

27. The system according to claim 26, wherein the terms of the option contract being set in accordance with a policy defined in the non-fungible token.

28. The system according to claim 26, wherein the programming instructions further comprise instructions to complete a second transaction in which the currency is exchanged for the option contract.

29. The system according to claim 28, wherein the programming instructions further comprise instructions to modify the first digital ledger to include information specifying details of the second transaction.

30. The system according to claim 20, wherein the programming instructions further comprise instructions to offer an ability to borrow or loan the collectible in exchange for currency in accordance with a policy defined in the non-fungible token.

31. The system according to claim 30, wherein the programming instructions further comprise instructions to complete a third transaction for borrowing or loaning the collectible and modifying the first digital ledger to include information specifying details of the third transaction.

32. The system according to claim 20, wherein the programming instructions further comprise instructions to continuously vary a price of the collectible based on an index, historical transaction data, and purchase transaction data received from other online exchange systems.

33. The system according to claim 20, wherein the programming instructions further comprise instructions to track changes in physical custody of the collectible and encode tracking updates into the first digital ledger so as to be tied to transaction history of the non-fungible token.

34. The system according to claim 20, wherein the programming instructions further comprise instructions to authenticate an identity of an individual prior to allowing the individual access to the online exchange system.

35. The system according to claim 20, wherein the non-fungible token is configured to verify ownership of one or more securitized tokens in addition to the ownership of the collectible.

36. The system according to claim 20, wherein the programming instructions further comprise instructions to generate and present a single graphical user interface simultaneously displaying streaming quotes for auctioned collectibles, non-functional tokens and derivatives.

37. The system according to claim 20, wherein the programming instructions further comprise instructions to organize assets of a plurality of different platforms in accordance with a data taxonomy that is defined by at least one of an asset class, a year of creation of a collectible, a company that made the collectible, a unique identifier for the collectible, a collectible type, a rating or verification agency classification, a fractionalization exchange offering indicator, an origin auction house identifier, and a listing expiration date.
